(19) United States
(12) Patent Application Publication
(10) Pub. No.: US 2009/0083377 A1
(43) Pub. Date: Mar. 26, 2009

(54) MEETING COORDINATOR

(76) Inventors: Sharon BEN-HAIM, Mevaseret Zion (IL); Halm Inger, Petach Tikva (IL); Boaz Dolev, Jerusalem (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/860,568

(22) Filed: Sep. 25, 2007

(51) Int. Cl. G06F 15/16

(52) U.S. Cl. 709/204

(57) ABSTRACT

The present invention is a new system and method for enabling multiple users of computerized schedulers to automatically find a time for a meeting. According to embodiments of the present invention a user of the system sends a request to other participants of the meeting to coordinate the meeting via a centralized platform, such as a network server. Provided that the invitation is accepted by the other participants, the central network server receives from the computerizes scheduler of each of the participants the available time according to their prospective schedules and finds a time when all participants can meet. According to embodiments of the present invention users can define their preferred time for the meeting. Having found a time when all participants can meet the system sends each of the participants a notification concerning the meeting and a request to approve the selected time.

### FIELD OF INVENTION

The present invention relates in general to the field of computerized schedulers, more particularly it relates to the field of computerized schedulers for automatically arranging multi-participant meetings.

### BACKGROUND OF THE PRIOR ART

Coordinating a multi-participant meeting for people with busy schedules may prove to be a difficult and time consuming task. This is especially true if different meeting participants have different preferences concerning the time of the meeting. Known in the art are several systems and methods for addressing this issue. For instant, U.S. Pat. No. 7,108,173 discloses a scheduling agent which is responsible for coordinating meeting activities for its associated user. Upon receiving a meeting request, the scheduling agents of the different participants negotiate to schedule the requested meeting at a most suitable time for all attendees.

Similarly, U.S. Pat. No. 6,101,480 discloses a system for scheduling time intervals for a plurality of users on a network. The system comprises a database in which a profile for each potential invitee is stored. The system further comprises request generators located remotely from the servers and connected over a network that generate a request for allocation of a time interval for one or more of the plurality of invitees. A device gathers the profiles for the invitees and determines whether they are available during the requested time interval. If not all invitees are available, a best fit determining system determines a next best time interval.

However there is a need for a web-based system and method which would allow users working in different organizations to automatically schedule a multi-participant meeting which would be best suited for the majority of its participants. Moreover, such a system and method should provide maximal security for its users by not exposing the content of their schedules to potential hackers and information leaks.

### SUMMARY OF INVENTION

Disclosed is a computerized method for the automatic scheduling of a meeting between at least two meeting participants, wherein the computerized schedule of the participants resides on an end unit and the automatic scheduling is performed on a central platform. The method comprises the steps of collecting the available time slots from the computerized schedule on the end units of the meeting participants and storing the available time slots on a storing unit of the central platform. The method also includes the steps of finding at least one time slot which suits the schedule of the meeting participants by the central platform and informing meeting participants of at least one possible time slot for the meeting. The central platform is connected to a wide area data communication network and the end units communicate with the central platform through the wide area network.

The method may also include the step of requesting the meeting participants to grade the found time slots for the meeting in accordance with the preferences of the meeting participants and select one time slot for the meeting in accordance with the preferences of meeting participants. The method may optionally include the step of automatically updating the scheduler on the end units of the meeting participants with meeting details. The collection of available time slots may be performed periodically, in accordance with predefined user preferences. The method may also include the step of requesting meeting participants to approve a request to schedule the meeting, and identifying the participants. The identification may be performed using a unique identifier, an email address or a full name.

Also disclosed is a computerized system for the automatic scheduling of a meeting between at least two meeting participants, wherein the computerized schedule of the participants resides on an end unit and the automatic scheduling is performed on a central platform. The system comprises a gathering module for collecting the available time slots from the computerized schedule on the end units of the meeting participants, and a storing unit for storing the available time slots, wherein the storing unit resides on the central platform. The system also comprises a matching module for finding at least one time slot which suits the schedule of the meeting participants, and a notification module for informing the meeting participants of at least one possible time slot for the meeting. The central platform is connected to a wide area data communication network and the end units communicate with the central platform through the wide area network.

The system may also include a grading interface through which the meeting participants are requested to grade the found time slots for the meeting in accordance with the preferences of the meeting participants. The matching module may select one time slot for the meeting in accordance with the preferences of the meeting participants. The notification module may update the scheduler on the end units of the meeting participants with meeting details. The gathering module may perform the collection of available time slots periodically; the periodic collection may be activated by the gathering module in accordance with predefined user preferences.

The notification module may request meeting participants to approve a request to schedule the meeting and may identify the participants. The identification of meeting participants may be performed using a unique identifier, an email address or a full name.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram illustrating the principal components of a meeting scheduling system in accordance with embodiments of the present invention;

FIG. 2 is a descending block diagram illustrating a meeting scheduling process in accordance with embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is a new system and method for enabling multiple users of computerized schedulers to automatically find a time for a meeting. According to embodiments of the present invention a user of the system sends a request to other participants of the meeting to coordinate the meeting via a centralized platform, such as a network server. Provided that the invitation is accepted by the other participants, the central network server receives from the computerizes scheduler of each of the participants the available time according to their prospective schedules and finds a time when all participants can meet. According to embodiments of the present invention users can define their preferred time for the meeting. Having found a time when all participants can meet the system sends each of the participants a notification concerning the meeting and a request to approve the selected time.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to he construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

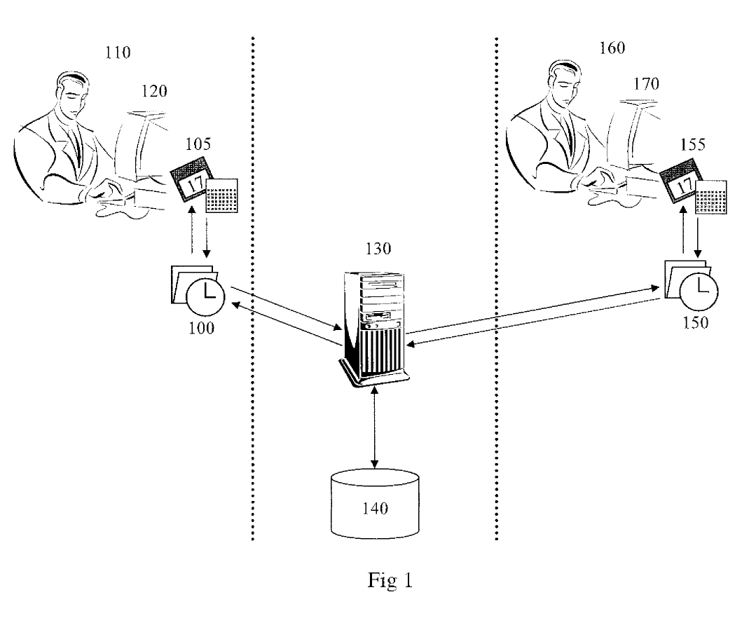

FIG. 1 is a block diagram illustrating the principal components of a meeting scheduling system in accordance with embodiments of the present invention. A designated software component 100 is installed on an end unit 120 of user 10. Such end unit, can optionally be embodied, without limitations, by a cellular telephone, by a wireless telephone, by a Personal Communication Systems (PCS) device, by a Personal Digital Assistant (PDA) device that incorporates a wireless communication device, by a tablet computer, by a server computer, by a personal computer, by a wireless communication station, by a mobile computer, by a notebook computer, by a desktop computer, by a laptop computer, by a PDA device, by a landline phone, a pager, by server, e.g. Short Message Service (SMS) server, Multimedia Messaging Service (MMS) server, internet server, and the like.

According to embodiments of the present invention software component 100 may be an independent scheduling application. According to additional embodiments of the present invention designated software component 100 communicates with a scheduling application on end unit 120 of user 110. Similarly, a designated software component 150 is installed on end unit 170 of user 160. When user 110 wishes to schedule a meeting with user 160, dedicated software component 100 sends a request to dedicated software component 150 on end unit 170 of user 160 through a centralized platform such as a web server 130. In order to schedule the meeting software components 100 of user 110 and software component 150 of user 170 each send the available times for the meeting to web server 130 according to the scheduling application 105 of user 110 and scheduling application 155 of user 150. For data security reasons, only the available time slots are sent to web server 130, and not the entire schedule.

Web server 130 receives requests from dedicated software component 100 of user 110 and dedicated software component 150 of user 160 and stores this information on storage unit 140. According to embodiments of the present invention storage unit 140 of server 130 holds all relevant information needed to perform the scheduling of the meeting. For instance, this information may include the time zones of the users, changes due to daylight saving times and the like. According to additional embodiments of the present invention, in order to determine the optimal time for the meeting server 130 may receive additional information about each of the users from dedicated software component 100 and dedicated software component 150. For instance, server 130 may receive information about the working hours of the users, their preferred time of day and day of the week for the meeting, and the like.

Server 130 finds the available times for the users to meet, and sends each of the dedicated software components 100, 150 the available times. Each of the users 110, 160 then selects his or her preferred time. According to the preferences of the users, server 130 selects the time which is best suited for each of the users 110, 160 for the meeting and informs dedicated software component 100 and dedicated software component 150. Dedicated software components 100, 150 automatically update scheduling application 105 and scheduling application 155 accordingly. The meeting appears on scheduling applications 105, 155 as normal meetings.

According to some embodiments of the present invention storage unit 140 of server 130 holds the available times for meetings of all of the users of the system. Thus, when two or more users wish to schedule a meeting, the system does not need to be updated. For this purpose, dedicated software components 100, 150 frequently update server 130 about changes in the available time slots the users have on their schedule automatically.

The above example relates to the scheduling of a meeting between only two users for the purpose of simplifying the explanation. The disclosed system allows the scheduling of multi-participant meetings. In such cases, the same components are available for each of the users, as illustrated for user 110 and user 160. A multi-participant meeting is scheduled by including all the relevant users in the process of request, notification and approval of the meeting.

Users of the system can determine their preferences for updating server 130 about their schedules. For instance, users can determine how often they wish the dedicated software component to update server 130 about changes in their schedules.

All data communication between server 130 and dedicated software components 100, 150 may be encoded for data security reasons. Similarly, information on storage unit 140 is encrypted and secured.

A storage unit such as, storage unit 140 can optionally be embodied, without limitations, by a hard disk drive, by a floppy disk drive, by a Compact Disk (CD) drive, by a CD-ROM drive, by a digital versatile disc (DVD) drive, or other suitable removable or non-removable storage units. Furthermore, storage unit 120 can optionally be embodied, for example, by a Random Access Memory (RAM), by a Dynamic RAM (DRAM), by a Synchronous DRAM (SD-RAM), by a Flash memory, by a volatile memory, by a non-volatile memory, by a cache memory, by a buffer, by a short-term memory unit, by a tong-term memory unit, or other suitable memory units or storage units.

According to some embodiments of the present invention users of the system can select which other users can request to schedule a meeting with them. If a first user wishes to schedule a meeting with a second user who did not authorize him for scheduling, dedicated software component of the first user sends a request to the dedicated software component of the second user and requests to be allowed to schedule a meeting.

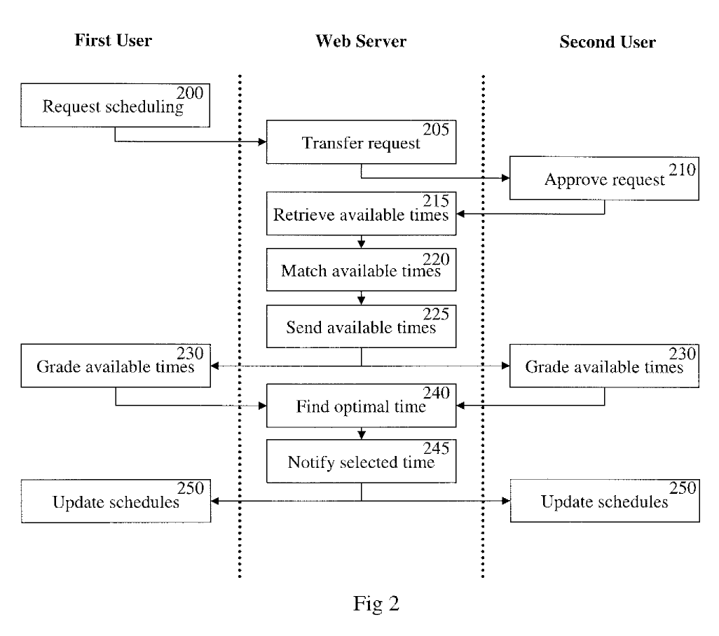

FIG. 2 is a descending block diagram illustrating a meeting scheduling process in accordance with embodiments of the present invention. First, a first user sends a request to schedule a meeting to the web server (step 200). The request includes identifying information of the second user, such as the email address or username of the second user. Provided that the second user already approved receiving meeting scheduling requests from the first user the method proceeds to the next step. If the second user did not already approve receiving meeting scheduling requests from the first user the second user is first asked to approve the request of the first user (step 210).

The method then retrieves the available time slots for the meeting participants (step 215). Next, the method matches the available times for the meeting participants and finds all time slots when the meeting participants can meet (step 220). The method then sends the details of the available time slots to the meeting participants (step 225). Each user is asked to grade the time slots in accordance with his or her preferences (step 230). According to the grades the users gave to each of the available time slots the method selects the time slot which is best suited (step 240). Finally the method sends the selected time to the dedicated software component on the end unit of each of the users (step 245) and the dedicated software component of each of the users updates the scheduler of the users (step 250).

The above example relates to the scheduling of a meeting between only two users for the purpose of simplifying the explanation. The disclosed method allows the scheduling of multi-participant meetings. In such cases, the same steps are performed while including all of the participants. A multi-participant meeting is scheduled by including all the relevant users in the process of request, notification and approval of the meeting.

It should be understood that some embodiments of the invention can optionally be implemented, for example, using a machine-readable medium or article which can optionally store an instruction or a set of instructions that, if executed by a machine, cause the machine to perform a method or operations or both in accordance with embodiments of the invention. Such a machine can optionally include, for example, any suitable processing platform, computing platform, computing device, processing device, computing system, processing system, computer, processor, or the like, and can optionally be implemented using any suitable combination of hardware or software or both. The machine-readable medium or article can optionally include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a rewritable DVD, a tape, a cassette, or the like. The instructions can optionally include any suitable type of code, for example, an executable code, a compiled code, a dynamic code, a static code, interpreted code, a source code or the like, and can optionally be implemented using any suitable high-level, low-level, object-oriented, visual, compiled or interpreted programming language. Such a compiled or interpreted programming language can optionally be, for example, C, C++, C#, .Net, Java, Pascal, MATLAB, BASIC, Cobol, Fortran, assembly language, machine code and the like.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A computerized method for the automatic scheduling of a meeting between at least two meeting participants, wherein the computerized schedule of said participants resides on an end unit and said automatic scheduling is performed on a central platform, said method comprising the steps of:
collecting the available time slots from said computerized schedule on said end units of said meeting participants;
storing said available time slots on a storing unit of said central platform;
finding at least one time slot which suits said schedule of said meeting participants by said central platform;
informing said meeting participants of at least one possible time slot for said meeting;
wherein said central platform is connected to a wide area data communication network and said end units communicate with said central platform through said wide area network.

2. The method of claim 1 further including the step of requesting said meeting participants to grade said found time slots for said meeting in accordance with the preferences of said meeting participants.

3. The method of claim 2 further including the step of selecting one time slot for said meeting in accordance with said preferences of said meeting participants.

4. The method of claim 1 further including the step of automatically updating the scheduler on said end units of said meeting participants with meeting details.

5. The method of claim 1 wherein said collection of available time slots is performed periodically.

6. The method of claim 5 wherein said periodic collection is performed in accordance with predefined user preferences.

7. The method of claim 1 further including the step of requesting meeting participants to approve a request to schedule said meeting.

8. The method of claim 1 further including the step of identifying said participants, wherein said identification is performed using at least one of the following: a unique identifier, an email address, a full name.

9. A computerized system for the automatic scheduling of a meeting between at least two meeting participants, wherein the computerized schedule of said participants resides on an end unit and said automatic scheduling is performed on a central platform, said system comprising:
a gathering module for collecting the available time slots from said computerized schedule on said end units of said meeting participants;
a storing unit for storing said available time slots, wherein said storing unit resides on said central platform;
a matching module for finding at least one time slot which suits said schedule of said meeting participants;
a notification module for informing said meeting participants of at least one possible time slot for said meeting;
wherein said central platform is connected to a wide area data communication network and said end units communicate with said central platform through said wide area network.

10. The system of claim 9 further including a grading interface through which said meeting participants are requested to grade said found time slots for said meeting in accordance with the preferences of said meeting participants.

11. The system of claim 1O wherein said matching module selects one time slot for said meeting in accordance with said preferences of said meeting participants.

12. The system of claim 9 wherein said notification module updates the scheduler on said end units of said meeting participants with meeting details.

13. The system of claim 9 wherein said gathering module performs said collection of available time slots periodically.

14. The system of claim 13 wherein said periodic collection is activated by said gathering module in accordance with predefined user preferences.

15. The system of claim 9 wherein said notification module requests meeting participants to approve a request to schedule said meeting.

16. The system of claim 9 wherein said notification module identifies said participants, wherein said identification is performed using at least one of the following: a unique identifier, an email address, a full name.
